(19) United States
(12) Patent Application Publication
(10) Pub. No.: US 2007/0097901 A1
(43) Pub. Date: May 3, 2007

(54) Apparatus, method and computer program product providing common channel arrangements for soft frequency reuse

(75) Inventors: Olav Tirkkonen, Helsinki (FI); Preben Mogensen, Gistrup (DK); Mika P. Rinne, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/588,519

(22) Filed: Oct. 27, 2006

Related U.S. Application Data
(60) Provisional application No. 60/731,552, filed on Oct. 28, 2005.

(51) Int. Cl. H04B 7/185

(52) U.S. Cl. 370/318; 455/522

(57) ABSTRACT

A device includes circuitry adapted to place at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and a transmitter to transmit the common channel into the cell for reception by a plurality of receivers. Also disclosed is a method and a computer program product operable with the device.

### CLAIM OF PRIORITY FROM COPENDING PROVISIONAL PATENT APPLICATION

This patent application claims priority under 35 U.S.C. §119(e) from Provisional Patent Application No. 60/731,552, filed Oct. 28, 2005, the disclosure of which is incorporated by reference herein in its entirety.

### TECHNICAL FIELD

The exemplary and non-limiting embodiments of this invention relate generally to wireless cellular communications systems and devices and, more specifically, relate to those wireless cellular communications systems that employ soft frequency reuse with channels transmitted to a receiver.

### BACKGROUND

The following abbreviations are herewith defined.

3GPP third generation partnership project

UTRAN universal terrestrial radio access network

E-UTRAN evolved UTRAN

CDM code division multiplex

CCH common channel

DL downlink (Node B to UE)

UL uplink (UE to Node B)

DSCH downlink shared channel

DRX discontinuous reception

DTX discontinuous transmission

DSP digital signal processor

FDM frequency division multiplex

FDMA frequency divisional multiple access

Node B base station

OFDM orthogonal frequency division multiplex

SR sub-band soft reuse sub-band

TDM time division multiplex

UE user equipment

WCDMA wideband code division multiple access

WCDMA LTE WCDMA long term evolution

Inter-cell interference is a serious problem that needs to be addressed during the design of a multi-cellular communication system. Some conventional systems reduce the amount of interference of geographically adjacent cells by allocating their carrier frequencies to different center frequencies, separated by the bandwidth of the carrier. Thus, there is a reuse factor, which determines tiers of geographical cells such that base stations transmitting on the same center frequency are much further away than the geographically closest neighbors. This approach is known to complicate network planning, since when introducing a new base station the operator may need to update the frequency plan of all the base stations in that area.

Some modern systems, such as WCDMA, are designed so that frequency reuse planning is not needed at all, i.e., full coverage network can be deployed by applying the same frequency in all the cells within a certain geographical area. This is also preferred as the system bandwidth can be large, e.g., 5 MHz for WCDMA. Thus, it would not be efficient to deploy such a wideband system with frequency reuse. WCDMA, as any modem signal structure, is designed so that a frequency reuse 1 deployment is possible, practical and efficient.

This same requirement has been set for E-UTRAN. The system bandwidth of E-UTRAN is scalable from values ranging from 1.25 MHz up to 20 MHz, and possibly even higher (e.g., up to 100 MHz).

E-UTRAN will be designed so that DL transmission is a multi-carrier signal, where a mathematical transform is applied to form sub-carriers, each of which carry modulated symbols. Such a block of sub-carrier symbols is referred to as an OFDM symbol, if the transforms applied are DFT or FFT transforms. Other types of multi-carrier compositions exist by other mathematical transforms, such as sine or cosine transforms, lapped transforms, bi-orthogonal transforms, isotropic transforms, etc. In the UL, the E-UTRAN may be a similar multi-carrier signal as well, but is presently defined as a single carrier, FDMA (SC-FDMA) characterized by a frequency division multiplex of users. In any of the afore-mentioned techniques, the frequency reuse 1 technique is feasible.

One potential solution to the inter-cell interference problem employs a so-called soft reuse method (in time/frequency). In a soft reuse method, different orthogonal transmission resources are given different transmission powers, and the power usage is planned in the cellular system on a cell-by-cell basis. While time domain soft reuse may be applied to any multiplexing technology, frequency domain soft reuse requires the presence of a multi-carrier system in order to be applicable.

While soft reuse has been considered in the time domain and in the frequency domain, a frequency domain arrangement is more advantageous in an asynchronous communication system. It has been stressed in the requirements for WCDMA LTE that the E-UTRAN should be operable in an asynchronous fashion (see 3GPP TR 25.913, “3rd Generation Partnership Project; Technical Specification Group Radio Access Network; Requirements for Evolved UTRA (E-UTRA) and Evolved UTRAN (E-UTRAN); (Release 7)”. As such, a frequency domain soft reuse implementation is a strong candidate for a LTE system architecture. Such has been suggested in 3GPP by Huawei (“Soft frequency reuse scheme for UTRAN LTE”, R1-050404, Athens meeting, May 2005). Reference may also be made to Alcatel, “Interference coordination in new OFDM DL air interface”, R1-050407, Athens meeting, May 2005 (attached hereto as Exhibit B), and to Ericsson, “Inter-cell interference handling for E-UTRA”, R1-050764, August 2005. Note also the “Flarion FLEXband” concept (Signals Ahead, Vol 2, no 3, February 2005).

Further, the concept of soft reuse is well described in the commonly assigned U.S. Pat. No. 6,259,685 B1, “Method for Channel Allocation Utilizing Power Restrictions”, Mika Rinne, Mikko Rinne and Oscar Salonaho, incorporated by reference herein.

Also of interest is 3GPP TR 25.814, “3rd Generation Partnership Project; Technical Specification Group Radio Access Network; Physical Layer Aspects for Evolved UTRA (Release 7)”.

### SUMMARY

In an exemplary aspect of the invention a method is provided that includes placing at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and transmitting the common channel into the cell for reception by a plurality of receivers.

In another exemplary aspect of the invention there is provided a computer program product having program instructions embodied on a tangible computer-readable medium, where execution of the program instructions results in operations that comprise placing at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and transmitting the common channel into the cell for reception by a plurality of receivers.

In a further exemplary aspect of the invention there is provided a device that includes circuitry adapted to place at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and a transmitter to transmit the common channel into the cell for reception by a plurality of receivers.

### BRIEF DESCRIPTION OF THE DRAWINGS

The foregoing and other aspects of embodiments of this invention are made more evident in the following Detailed Description, when read in conjunction with the attached Drawing Figures, where:

FIG. 1 shows a simplified block diagram of various electronic devices that are suitable for use in practicing the exemplary embodiments of this invention;

FIG. 2 depicts an example of a power mask of a cell in a soft-reuse system;

FIG. 3 shows a non-limiting example of sub-frame formats for the cell depicted in FIG. 2;

FIG. 4 shows a non-limiting example of sub-frame formats for the cell depicted in FIG. 2, with at least a portion of a Syslnfo field in a fixed resource for directly signaling CCH placement; and

FIGS. 5 and 6 are logic flow diagrams descriptive of the operation of a transmitter and a receiver, respectively, in accordance with exemplary embodiments of this invention.

### DETAILED DESCRIPTION

The exemplary embodiments of this invention pertain generally to multi-cellular, multi-carrier communication systems, such as one known as evolved UTRAN (E-UTRAN) being standardized in the 3GPP. However, the exemplary embodiments of this invention should not be construed as being limited for use with only one particular type of wireless communications system, or with only one particular type of wireless communications system access technology.

A problem that is addressed and solved by the exemplary embodiments of this invention is in the area of the design of common channels in a system where soft reuse may be applied at least partly in the frequency domain. Common channels (common to more than one user terminal device) are preferably designed so that they may be detected as reliably as is possible over the entire cell coverage area. It should be appreciated that for this to occur the facilitation of soft reuse, often understood as being a technology that does not need specification, still has implications for standards specifications.

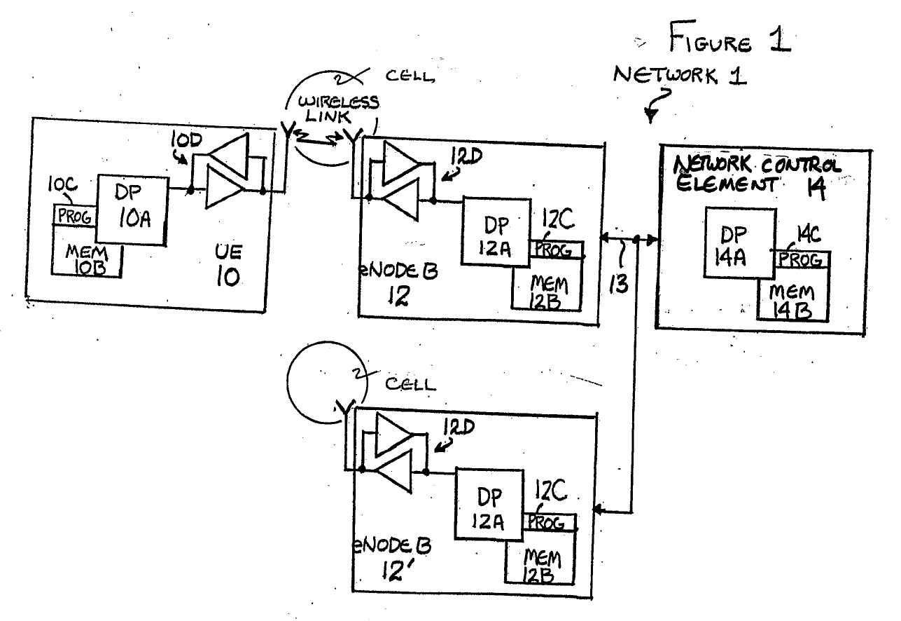

Reference is made to FIG. 1 for illustrating a simplified block diagram of various electronic devices that are suitable for use in practicing the exemplary embodiments of this invention. In FIG. 1 a wireless network 1 is adapted for communication with a UE 10 via at least one Node B (base station) 12 (also referred to herein as an eNode B 12). The network 1 may include a network control element 14 coupled to the eNode B 12 via a data link 13. The UE 10 includes a data processor (DP) 10A, a memory (MEM) 10B that stores a program (PROG) 10C, and a suitable radio frequency (RF) transceiver 10D for bidirectional wireless communications with the eNode B 12, which also includes a DP 12A, a MEM 12B that stores a PROG 12C, and a suitable RF transceiver 12D. The eNode B 12 is typically coupled via the data path 13 to the network control element 14 that also includes at least one DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail.

Shown for completeness in FIG. 1 is at least one second eNode B, referred to as 12′. Note that in practice the cells of adjacent eNodeBs may at least partially overlap one another.

Although the Node B 12 is shown having one antenna 13, in practice there may be a plurality of antennas at least for transmitting to the UE 10. Similarly, the UE 10 is depicted with one antenna, but in practice there may be a plurality of antennas.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Note that some aspects of the exemplary aspects of this invention will be practiced by the eNode Bs 12, 12′, while certain other aspects, such as those related to overall control and coordination between the eNode Bs 12, 12′, such as for the use and re-use of resources, may at least partly be performed at or by the network control element 14. It is pointed out that the network control element need not be an active element of the system/data architecture, but may be embodied as operator's tools for tuning, controlling and optimizing the network.

Turning now to a detailed discussion of the exemplary embodiments of this invention, it is first noted that one of the advantages of frequency domain soft reuse is that it does not require standardization. When employing soft frequency reuse, the transmit power level used on different frequency bands (referred to as soft reuse bands below) is made different, and this different power usage may change from cell-to-cell. This has been previously discussed in 3GPP, see, e.g., the above-cited: Ericsson, “Inter-cell interference handling for E-UTRA”, R1-050764, August 2005.

Soft reuse may be implemented by a wireless network provider as a slowly time varying network optimization feature. When applying non-standardized soft reuse, the power of pilots transmitted within a soft reuse band reflect the power used for data transmission in the same soft reuse band. As an example, in soft frequency reuse OFDM, pilot subcarriers in a soft reuse band are transmitted with a power that depends on the power used on the data subcarriers in the same band. In this case a possible change of transmission power level from one soft reuse band to another need not be signaled, since the UE 10 would automatically detect the changes in transmission power when receiving the pilot symbols. Note that this feature is not compromised by having a (standardized or signaled) pilot offset. Such an offset would imply that pilots are transmitted with a fixed power offset as compared to data symbols, e.g., 3 dB. This offset would be the same for all soft reuse bands, and thus by knowing the pilot offset, and by estimating the pilots, the UE 10 would have knowledge of the received power on the data subcarriers, irrespective of possible soft reuse induced differences in transmission power.

However, if the potential of soft reuse is to be fully exploited, the transmission resources that have higher power should be utilized for the transmission of information that requires especially high reliability. For example, common channels (CCH) should be reliably detected by all users in the cell (and potentially also by users in adjacent cells). In E-UTRA, for example, the common channels may be used, for example, to allocate physical layer resources to users (e.g., through the use of an Allocation Table), and for broadcasting system information (SysInfo) to the users.

In general, the common channels may need to be received by all active UEs 10 in the cell, and often no user-specific SINR (signal-to-interference noise ratio) information may be used for selecting the transmission format. Thus, CCHs should be encoded robustly to ensure a high detection probability.

Due to these various characteristics, if soft reuse is employed the common channels should advantageously be transmitted on resources (e.g., on soft reuse frequency bands) that have a higher transmit power in the cell. However, this approach may be expected to require standardization, as the orthogonal resources in time-frequency (and possibly code) where most common channels are transmitted should be variable from cell to cell, and it should thus be possible to signal their placement to the UEs 10 by at least one of the common channels.

In accordance with the exemplary embodiments of this invention, at least a portion of the common channels are primarily placed on a fraction of the available bandwidth. This fraction may be different in different cells in the network, and the placement of this bandwidth fraction in a cell (and possibly neighboring cells) is signaled to the users.

The signaling of CCH placement may be direct, so that there is, e.g., an indicator in a special system information field that indicates where to find other common channels. Such a system information field is preferably transmitted in a specified time-frequency-code resource in a radio frame so that it can be located by the UE 10 without searching. Thus, at least that portion of the CCH that carries information about the Syslnfo field need not always be transmitted on a resource having higher transmission power.

In accordance with the exemplary embodiments of this invention, the signaling of the CCH placement may be implicit. This may be arranged, for example, so that there is a set of possible pilot codes that may be used in a cell. As an example, the set may contain 128 different pilot codes. When synchronizing to the cell during an initial cell search procedure, the pilot code is acquired by measurements and sequence detection. For handover, the pilot code of neighboring cells may be indicated in one or more system information transmissions from each cell.

In accordance with the exemplary embodiments of this invention that employ implicit signaling, the possible pilot codes are divided into sets so that the subband(s) where control channels are to be found depend on which pilot code set the pilot code of the cell belongs to. Thus, for a soft frequency reuse factor of three, the 128 (by example) pilot codes may be divided into three sets with, for example, 42 pilot codes in one set and 43 in each of the other two sets. A more natural numerology, consistent with the soft reuse factor 3, would be to have, for example, 32 or 64 codes in a set, with 96 or 192 codes totally. One advantage of this approach is that when soft reuse is planned in the network the pilot code planning is automatically facilitated, and vice versa. Further, all system information may be placed on resources that enjoy better performance, as the UE 10 performing a cell search would know here to look for system information as soon as the UE 10 is able to synchronize to the cell, i.e., as soon as the UE 10 has identified the pilot code used in that cell.

One non-limiting approach to implement this technique, and to gain the benefits for synchronization channels as well, is to design secondary synchronization channels in a FDM manner. Secondary synchronization channels (S-SCH) are such that not all cells in a system transmit the same S-SCH, and not all cells transmit different S-SCHs. By synchronizing to the S-SCH the UE 10 may gain knowledge of the pilot (or scrambling) code group used in the cell. That is, after successful reception of the S-SCH the UE 10 knows that the pilot (scrambling) code is one out of a group of several codes. The S-SCHs may be arranged so that part of the S-SCH identity is the set of subcarriers that the S-SCH is transmitted on. According to exemplary embodiments of the invention, the S-SCH identity further indicates in which resources at least a portion of the one common channel is transmitted.

In accordance with the exemplary embodiments of this invention the S-SCH may be transmitted in a portion of the spectrum having higher transmission power so as to improve at least the synchronization performance of the UE 10. This may be exemplified in the example of 128 pilot codes, discussed above, with 42, 43 and 43 pilot codes in the sets indicating that common channels are to be found on frequency resources 1, 2 and 3, respectively. In such an arrangement the possible S-SCHs may be divided into three sets. As a non-limiting example, in the first set the possible S-SCHs indicate a group of possible pilot codes in the first set of 42 codes, and directly indicate that common channels are to be found on frequency resource 1. In the second set the possible S-SCHs indicate a group of possible pilot codes in the second set of 43 codes, and directly indicate that common channels are to be found on frequency resource 2. In the third set the possible S-SCHs indicate a group of possible pilot codes in the third set of 43 codes, and directly indicate that common channels are to be found on frequency resource 3.

To obtain the benefits of soft reuse to improve synchronization performance the three sets of S-SCH codes may be frequency division multiplexed, i.e., transmitted on the same frequency resource as the S-SCH identity that indicates where the CCHs are transmitted.

It should be appreciated that control channels may primarily be transmitted on resources with higher power. However, this is not meant to imply that control channels should never be transmitted on resources with lower power. For example, if a multistage approach is used for control channel encoding, where there is a first part of the control channel that has higher protection against errors than a second part, the first part could be transmitted on resources with higher transmit power. This first part may be used to allocate users in degraded channel conditions.

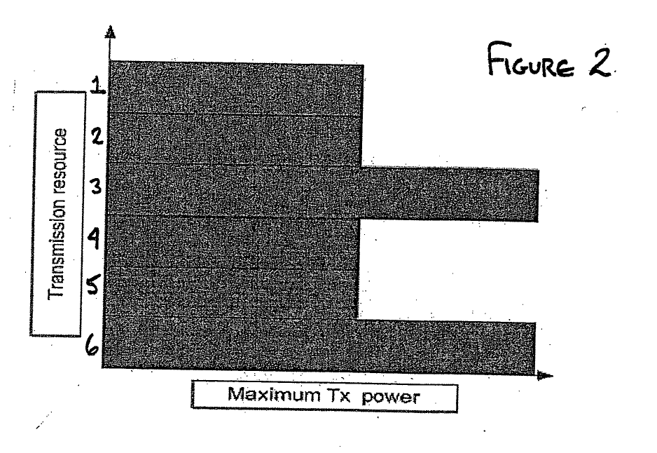

As is shown with regard to the FIGS. 2, 3 and 4, primary and secondary placements for CCHs are indicated. The primary placements of CCHs may be used for Syslnfo (to the degree possible). The primary placements of CCHs are preferably used for allocating UEs 10 in weak channel conditions. The secondary placements, if needed, may be used to allocate UEs 10 in better channel conditions.

In FIG. 2 an exemplary power mask is depicted for an exemplary cell in a system applying soft reuse. The transmission resources on the y-axis can include, at least in part, frequency division multiplexed (FDM) resources. For a non-limiting example that pertains to E-UTRA, the frequency resource may be one of the bandwidth alternatives of 1.25 MHz, 2.5 MHz, 5 MHz, 10 MHz, 15 MHz, 20 MHz. In FIG. 2 the resources (e.g., bandwidth) are divided into six parts, and in the cell two of the resources are used with a higher allowed transmission power than the remaining four resources. Thus, there is frequency diversity in each of the soft reuse patterns, and higher power transmission may be concentrated in more than one part of the spectrum. In the exemplary allocation shown in FIG. 2 the diversity degree is 2.

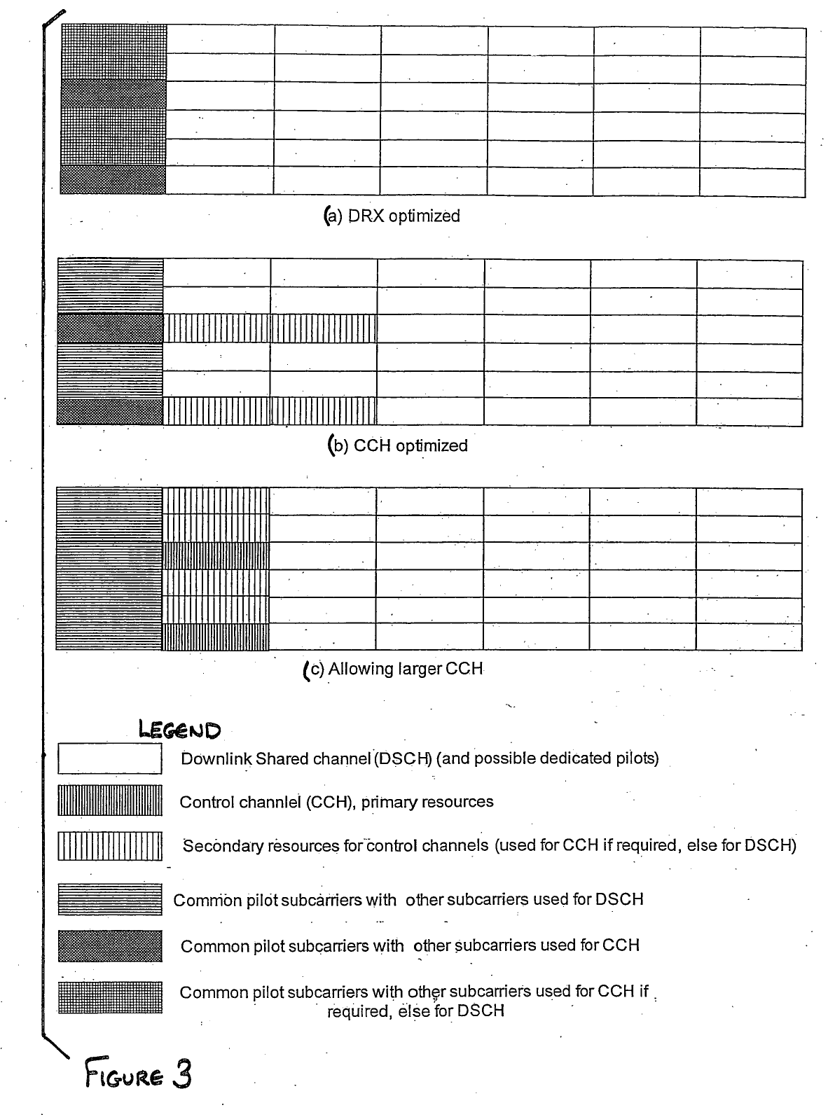

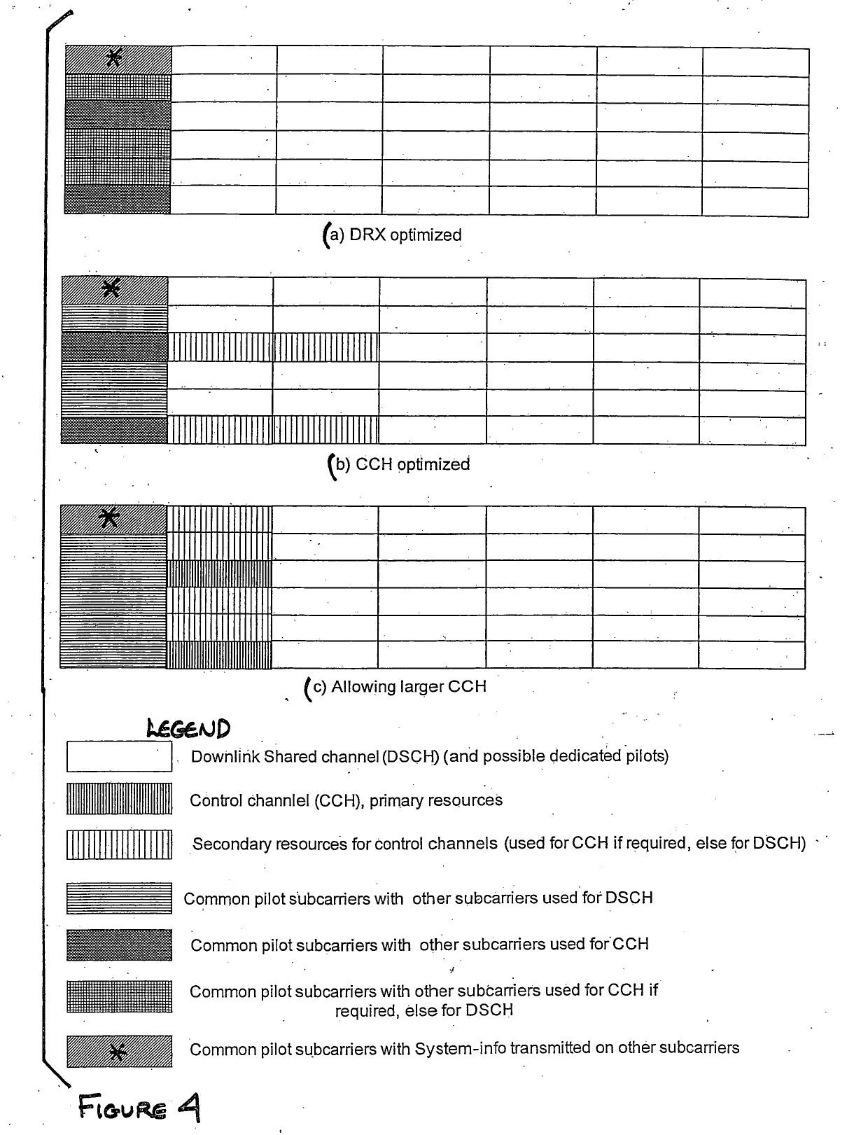

FIG. 3 shows a non-limiting example of sub-frame formats for the cell depicted in FIG. 2, and FIG. 4 shows a non-limiting example of sub-frame formats for the cell depicted in FIG. 2 with a portion of the SysInfo placed into a fixed resource (in this non-limiting example in the fixed resource labeled as #1 in FIG. 2).

More specifically, in FIG. 3 exemplary EUTRAN downlink sub-frame formats in the cell applying the power mask according to FIG. 2 are depicted. The sub-frame consists of seven OFDM symbols, and the subcarriers in each of these symbols are divided into six parts, on which the power mask of FIG. 2 is used.

In FIG. 3 (a) the common channel placement is optimized to minimize the power usage of a DRX/DTX user. For this purpose the common pilots and common channels are placed in the same OFDM symbol, and in this case simply by receiving this symbol the UE 10 may estimate the channel and obtain information related to future allocations. The CCHs are primarily transmitted on the resources allowing higher transmission power. If these resources are not sufficient, the lower power resources in the same symbol may be used.

In FIG. 3 (b) the common channel placement is optimized so that the performance of the CCHs is made as efficient as possible. In this case the common channels are always transmitted on the resources that allow the highest transmit power, primarily in the same OFDM-symbol as the common pilots.

In FIG. 3 (c) the common channels are placed in an OFDM symbol adjacent to a symbol with common pilots. This scheme provides an advantage that larger CCHs may be accommodated. Also, since processing may potentially execute in a serial fashion, the channel estimation that begins after receiving the symbol with common pilots would be ready when the second symbol with the CCHs would be available for processing.

FIG. 4 shows exemplary EUTRAN down-link sub-frame formats in the cell having the power mask according to FIG. 2, for a case of direct signaling of the CCH placements. Thus, the cell search procedure may follow the pattern of primary resources, even without an implicit signaling of the primary resources. Direct signaling, or explicit signaling, implies that there is a field (e.g. a SysInfo field) where a UE 10 performing a cell search can find information that indicates (explicitly) the placement of any one or all of the CCHs. This field is preferably indicated in a subset of all sub-frames, according to the pertinent frame format where synchronization channels are placed in an appropriate manner. In FIGS. 4 (a), (b) and (c) it can be seen that a fixed location for at least a part of the Syslnfo has been added to the sub-frames according to FIGS. 3 (a), (b) and (c). This (at least) part of the SysInfo field indicates where CCHs may be found, or at least where allocation tables and possibly the remaining part of the SysInfo may be found.

Based on the foregoing it should be appreciated that at least one advantage that can be realized by the use of the exemplary embodiments of this invention is that common channel performance may be optimized in a situation where soft reuse is used.

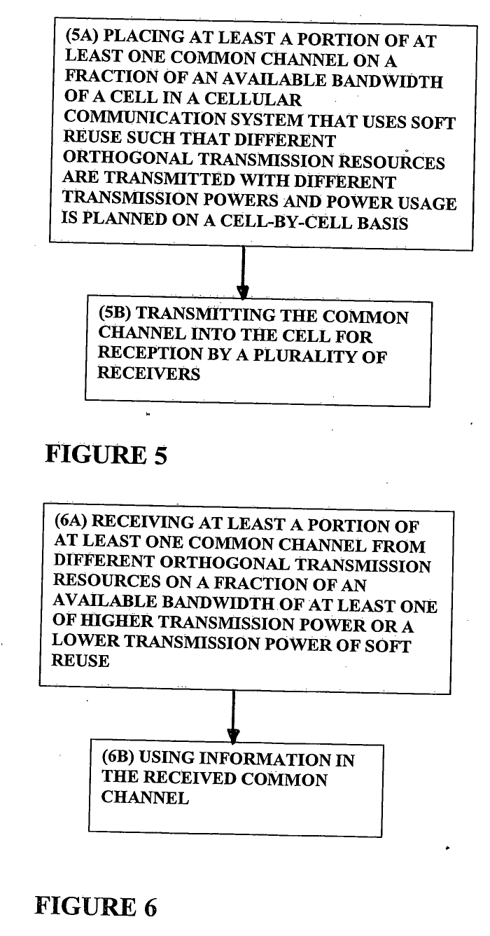

Referring to FIG. 5, it should be appreciated that a method in accordance with the exemplary embodiments of this invention, and the operation of a computer program product, includes (Block 5A) placing at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and (Block 5B) transmitting the common channel into the cell for reception by a plurality of receivers.

Referring to FIG. 6, it should be appreciated that a further method in accordance with the exemplary embodiments of this invention, and the operation of a computer program product, includes (Block 6A) receiving at least a portion of at least one common channel from different orthogonal transmission resources on a fraction of an available bandwidth of at least one of higher transmission power or a lower transmission power of soft reuse; and (Block 6B) using information in the received common channel.

The various blocks shown in FIGS. 5 and 6 may be viewed as method steps, and/or as operations that result from operation of computer program code, and/or as a plurality of coupled logic circuit elements constructed to carry out the associated function(s).

In general, the various embodiments may be implemented in hardware or special purpose circuits, software, logic, Application Specific Integrated Circuits (ASICs) or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of various embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
placing at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and
transmitting the common channel into the cell for reception by a plurality of receivers.

2. The method of claim 1, where the orthogonal transmission resources are at least one of frequency domain sub-carriers, time domain slots or code domain sequences.

3. The method of claim 1, where the soft reuse comprises a frequency domain soft reuse, where the cellular communication system comprises a multi-carrier system having a plurality of frequency bands, where a power of at least one pilot symbol transmitted within a certain frequency band corresponds to a power used for transmission in the soft reuse frequency band.

4. The method of claim 1, where a transmission resource having a higher power is utilized for transmission of information that requires a higher reliability.

5. The method of claim 4, where the information that requires a higher reliability comprises the at least one common channel.

6. The method of claim 1, where the cellular communication system comprises an E-UTRA system, where the at least a portion of one common channel is used to allocate physical layer resources.

7. The method of claim 1, where the cellular communication system comprises an E-UTRA system, where the at least a portion of one common channel is used to broadcast system information to the receivers.

8. The method of claim 1, further comprising:
implicitly signaling the placement of the at least one common channel to the plurality of receivers.

9. The method of claim 8, where implicitly signaling comprises partitioning a set of possible pilot codes into subsets such that the location of the at least a portion of one common channel is implicitly specified by which pilot code subset a particular pilot code belongs to.

10. The method of claim 9, where a soft frequency reuse factor comprises a number corresponding to the number of pilot code subsets.

11. The method of claim 1, further comprising:
explicitly signaling the placement of the at least a portion of one common channel to the plurality of receivers.

12. The method of claim 11, where explicitly signaling comprises use of an indicator in a system information message to indicate where to find other common channels.

13. The method of claim 12, where the indicator is transmitted in a specified time-frequency-code resource in a radio frame.

14. The method of claim 1, where orthogonal resources in at least one of time and frequency for the at least a portion of one common channel are different from cell to cell.

15. The method of claim 1, where the fraction of the available bandwidth is different between the cell and another cell.

16. The method of claim 1, further comprising transmitting at least one secondary synchronization channel on at least one frequency subcarrier for use by a receiver for synchronizing to the secondary synchronization channel to determine a pilot code set of a pilot code used in the cell.

17. The method of claim 16, where the at least one secondary synchronization channel is arranged on at least one frequency subcarrier for identifying on which the at least a portion of one common channel is transmitted.

18. The method of claim 16, where the at least one secondary synchronization channel is transmitted on a frequency subcarrier having a higher power than another frequency subcarrier.

19. The method of claim 16, where a plurality of secondary synchronization channels are frequency division multiplexed.

20. The method of claim 1, where the at least one control channel comprises a first part and a second part, where the first part has higher protection against errors than the second part, where the first part is transmitted to have a higher transmit power that the second part.

21. The method of claim 20, where the first part is used to allocate the receivers in degraded channel conditions.

22. A computer program product comprising program instructions embodied on a tangible computer-readable medium, execution of the program instructions resulting in operations comprising:
placing at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and
transmitting the common channel into the cell for reception by a plurality of receivers.

23. The computer program product of claim 22, where the orthogonal transmission resources are at least one of frequency domain sub-carriers, time domain slots or code domain sequences.

24. The computer program product of claim 22, where the soft reuse comprises a frequency domain soft reuse, where the cellular communication system comprises a multi-carrier system having a plurality of frequency bands, where a power of at least one pilot symbol transmitted within a certain frequency band corresponds to a power used for transmission in the soft reuse frequency band.

25. The computer program product of claim 22, where a transmission resource having a higher power is utilized for transmission of information that requires a higher reliability, and where the information that requires a higher reliability comprises the at least a portion of one common channel.

26. The computer program product of claim 22, where the cellular communication system comprises an E-UTRA system, where the at least one common channel is used to allocate physical layer resources.

27. The computer program product of claim 22, where the cellular communication system comprises an E-UTRA system, where the at least one common channel is used to broadcast system information to the receivers.

28. The computer program product of claim 22, further comprising an operation of:
implicitly signaling the placement of the at least a portion of one common channel to the plurality of receivers.

29. The computer program product of claim 28, where implicit signaling comprises partitioning a set of possible pilot codes into subsets such that the location of the at least a portion of one common channel is implicitly specified by to which pilot code subset a particular pilot code belongs.

30. The computer program product of claim 22, further comprising an operation of:
explicitly signaling the placement of the at least one common channel to the plurality of receivers.

31. The computer program product of claim 30, where explicitly signaling comprises use of an indicator in a system information message to indicate where to find other common channels, where the indicator is transmitted in a specified time-frequency-code resource in a radio frame.

32. The computer program product of claim 22, where orthogonal resources in at least one of time and frequency for the at least a portion of one common channel are different from one cell to another cell, and where the fraction of the available bandwidth is different between the one cell and another cell.

33. The computer program product of claim 22, further comprising transmitting at least one secondary synchronization channel on at least one frequency subcarrier for use by a receiver in synchronizing to the secondary synchronization channel to determine a pilot code set of a pilot code used in the cell.

34. The computer program product of claim 33, where the at least one secondary synchronization channel is transmitted on a frequency subcarrier having a higher power than another frequency subcarrier.

35. The computer program product of claim 22, where a plurality of secondary synchronization channels are frequency division multiplexed.

36. A computer program product comprising program instructions embodied on a tangible computer-readable medium, execution of the program instructions resulting in receiver operations comprising:
receiving at least a portion of at least one common channel from different orthogonal transmission resources on a fraction of an available bandwidth of at least one of higher transmission power or a lower transmission power of soft reuse; and
using information in the received common channel.

37. The computer program product of claim 36, where the orthogonal transmission resources are at least one of frequency domain sub-carriers, time domain slots or code domain sequences.

38. The computer program product of claim 36, where the soft reuse comprises a frequency domain soft reuse, where a cellular communication system comprises a multi-carrier system having a plurality of frequency bands, where a power of at least one pilot symbol transmitted within a certain frequency band corresponds to a power used for transmission in the soft reuse frequency band.

39. The computer program product of claim 36, where a placement of the at least a portion of one common channel is at least one of implicitly or explicitly signaled to the receiver.

40. The computer program product of claim 36, further comprising receiving at least one secondary synchronization channel on at least one frequency subcarrier to determine a pilot code set of a pilot code used in a cell.

41. A device comprising:
circuitry adapted to place at least a portion of at least one common channel on a fraction of an available bandwidth of a cell in a cellular communication system that uses soft reuse such that different orthogonal transmission resources are transmitted with different transmission powers and power usage is planned on a cell-by-cell basis; and
a transmitter to transmit the common channel into the cell for reception by a plurality of receivers.

42. The device of claim 41, where the orthogonal transmission resources are at least one of frequency domain sub-carriers, time domain slots or code domain sequences.

43. The device of claim 41, where the soft reuse comprises a frequency domain soft reuse, where the cellular communication system comprises a multi-carrier system having a plurality of frequency bands, where a power of at least one pilot symbol transmitted within a certain frequency band corresponds to a power used for transmission in the soft reuse frequency band.

44. The device of claim 41, where a transmission resource having a higher power is utilized for transmission of information that requires a higher reliability, where the information that requires a higher reliability comprises the at least a portion of one common channel.

45. The device of claim 41, where the cellular communication system comprises an E-UTRA system, where the at least one common channel is used to at least one of allocate physical layer resources and to broadcast system information to the receivers.

46. The device of claim 41, said circuitry further adapted to at least one of implicitly and explicitly signal the placement of the at least one common channel to the plurality of receivers, where implicit signaling comprises partitioning a set of possible pilot codes into subsets such that the location of the at least a portion of one common channel is implicitly specified by to which pilot code subset a particular pilot code belongs, and where explicitly signaling comprises use of an indicator in a system information message to indicate where to find a common channel.

47. The device of claim 41, said circuitry and transmitter further adapted to transmit at least one secondary synchronization channel on at least one frequency subcarrier for use by a receiver in synchronizing to the secondary synchronization channel to determine a pilot code set of a pilot code used in the cell.

48. The device of claim 47, where the determined pilot code set of a pilot code indicates where the at least a portion of one common channel is transmitted.

49. The device of claim 47, where the at least one secondary synchronization channel is transmitted on a frequency subcarrier having a higher power than another frequency subcarrier.

50. The device of claim 47, where a plurality of secondary synchronization channels are frequency division multiplexed.

51. The device of claim 41, where said circuitry is embodied in at least one integrated circuit.

52. The device of claim 41, embodied in a base station.

53. A device comprising circuitry adapted to receive at least a portion of at least one common channel from different orthogonal transmission resources on a fraction of an available bandwidth of at least one of higher transmission power or a lower transmission power of soft reuse.

54. The device of claim 53, where the orthogonal transmission resources are at least one of frequency domain sub-carriers, time domain slots or code domain sequences.

55. The device of claim 53, where the soft reuse comprises a frequency domain soft reuse, where a cellular communication system comprises a multi-carrier system having a plurality of frequency bands, where a power of at least one pilot symbol transmitted within a certain frequency band corresponds to a power used for transmission in the soft reuse frequency band.

56. The device of claim 53, where a placement of the at least a portion of one common channel is at least one of implicitly or explicitly signaled to the device.

57. The device of claim 53, further comprising receiving at least one secondary synchronization channel on at least one frequency subcarrier for use in synchronizing to the secondary synchronization channel to determine a pilot code set of a pilot code used in a cell.

58. The device of claim 53, where said circuitry is embodied in at least one integrated circuit.

59. The device of claim 53, embodied in a user equipment.
